(19) United States
(12) Patent Application Publication
(10) Pub. No.: US 2005/0158005 A1
(43) Pub. Date: Jul. 21, 2005

(54) Optical fiber holding member and method of manufacturing the same

(75) Inventors: Hiroyuki Otsuka, Kusatsu-shi (JP); Shigekazu Aoki, Omihachiman-shi (JP); Masayoshi Tani, Yokaichi-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/035,794

(22) Filed: Jan. 14, 2005

(30) Foreign Application Priority Data
Jan. 15, 2004 (JP) 2004-008566

(51) Int. Cl. G02B 6/00

(52) U.S. Cl. 385/137

(57) ABSTRACT

An optical fiber holding member in which occurrence of defectives is prevented by increasing the degree of accuracy in pitches of the optical fibers with a simplified manufacturing method, and a method of manufacturing the same are provided. A deflection generating block is disposed in a cavity for molding a holder, and a positioning block is disposed in contact with the cavity. The deflection generating block is formed with V-shaped holding grooves for the optical fibers. The positioning block has grooves for placing the optical fibers. The holding grooves and the grooves are shifted laterally of the extending direction of the optical fibers. The optical fibers and the positioning surfaces of the grooves are in press-contact by a resilient restoring force of the optical fibers, and are positioned in the lateral or vertical direction. In this state, resin is injected into the cavity, whereby obtaining the optical fiber holding member.

### BACKGROUND OF THE INVENTION

1. Field of the Invention

The present invention relates to an optical fiber holding member used for an optical communication device or the like and a method of manufacturing the same.

2. Description of the Related Art

(Example of Related Art 1)

FIG. 1 is a perspective view showing a method of manufacturing an optical fiber holding member in the related art. This example of the related art is a method of using a holder 1 formed of resin in advance. A holder 1 is formed with a plurality of through-holes 2 for inserting optical fibers, and is provided with a window 3 opened on top at the center thereof. The optical fiber holding member is assembled by the steps of peeling coating 5 of an optical fiber cable conductor 4 (tape cable conductor) to expose optical fibers 6 (element wires), inserting the respective optical fibers 6 into the through-holes 2 of the holder 1, dropping heat-hardening adhesive 7 into the holder 1 through the window 3 and hardening the same, and fixing the optical fibers 6 with the heat-hardening adhesive 7 to the holder 1.

According to the manner described above, if the diameters of the through-holes 2 are equal to those of the optical fibers 6, the optical fibers 6 can be arranged at regular pitches with high degree of accuracy. However, when the diameters of the through-holes 2 are equal to those of the optical fibers 6, it becomes difficult to insert the optical fibers 6 into the through-holes 2 of the holder 1, thereby deteriorating the efficiency of assembly. In contrast, when the accuracy of the through-holes 2 is low, the pitch accuracy of the optical-fibers 6 is lowered correspondingly.

According to the method described above, since the holder 1 is manufactured in advance, and the optical fibers 6 are built in the holder 1 and fixedly integrated with adhesive, the steps in the method of manufacturing the optical fiber holding member increase.

(Example of Related Art 2)

FIG. 2 is a perspective view showing another method of manufacturing an optical fiber holding member in the related art. In this example of related art, the optical fiber holding member is manufactured by the steps of arranging the optical fibers 6 being exposed from the coating 5 on a glass substrate 9 formed with V-shaped grooves 8 at regular pitches by cutting process, dropping UV-cured adhesive (UV adhesive) 10 on the glass substrate 9, pressing the same by a glass holding plate 11 from above, and curing the UV-cured adhesive 10 by irradiating an ultra-violet ray through the glass holding plate 11.

In the optical fiber holding member of this type, as shown in FIG. 3A, since the axial center of the optical fiber 6 passes through the center C of the V-shaped groove 8, the pitches of the optical fibers 6 arranged thereon become constant if the V-shaped grooves 8 are formed at regular pitches. In practice, however, when the optical fibers 6 with smaller diameter with respect to the V-shaped grooves 8 are employed, or when the thickness of the UV-cured adhesive 10 is too large as shown in FIG. 3B, there may be the case that the optical fibers 6 are lifted or displaced in the V-shaped grooves 8 and hence the regular pitches of the optical fibers 6 is not achieved.

The optical fiber holding member as described above is costly since the glass substrate 9 or the glass holding plate 11 is expensive, and the number of steps in the manufacturing method is large.
[Patent Document 1] JP-A-60-135911
[Patent Document 2] JP-A-61-110107
[Patent Document 3] JP-A-5-27144

### SUMMARY OF THE INVENTION

In view of such technological problem, it is an object of the present invention to provide an optical fiber holding member in which occurrence of defectives is prevented by increasing the degree of accuracy in pitches of the optical fibers with a simplified manufacturing method, and a method of manufacturing the same.

A method of manufacturing an optical fiber holding member according to the invention is a method of manufacturing an optical fiber holding member by inserting a plurality of optical fibers arranged in parallel into a resin holder, including a first step of arranging the respective optical fibers in parallel to each other in a plurality of positioning grooves in a cavity of a molding die and pressing the respective optical fibers against the grooves while causing the respective optical fibers to deflect in the direction substantially orthogonal to the axial direction thereof, and a second step of filling resin in the cavity of the molding die for forming the holder.

According to the method of manufacturing an optical fiber holding member of the invention, since resin is filled in the cavity of the molding die in a state in which the respective optical fibers are pressed against the grooves while being resiliently deflected in the direction substantially orthogonal to the axial direction to form the holder, positioning of the optical fibers in the grooves is ensured, and in particular, the optical fibers are hardly separated from the groove by resin which is flowing during resin molding. Therefore, according to the invention, positioning of the respective optical fibers is ensured by placing the respective optical fibers in the grooves, and hence the respective optical fibers can be arranged at regular pitches with high degree of accuracy. Since the holder can be formed by injection molding with the optical fiber inserted, the optical fiber holding member can be manufactured easily and at low cost.

According to an embodiment of the method of manufacturing an optical fiber holding member of the invention, the positioning member formed with the grooves is disposed at the position adjacent to the cavity of the molding die. In this embodiment, since the positioning member formed with the grooves is not within the cavity, and is disposed at the position adjacent to the cavity, the positioning member is not inserted into the holder. Therefore, since the positioning member can be used repeatedly, the cost of the optical fiber holding member can be reduced. Since the positioning member can be used repeatedly, the positioning member with high degree of accuracy in pitch of the grooves can be used, whereby the accuracy of the array pitch of the optical fibers can further be improved.

In the first step of another embodiment of the method of manufacturing an optical fiber holding member of the invention, a reference surface for pressing and positioning is placed on the positioning member formed with the grooves, and the optical fibers are deflected in the direction substantially orthogonal to the axial direction thereof and are pressed against the reference surface for pressing and positioning. In this embodiment, the optical fibers are brought into abutment with the reference surface for pressing and positioning for positioning the optical fibers in the vertical direction, and hence the respective optical fibers can be brought into resilient abutment with the reference surface for pressing and positioning. Therefore, the positioning of the optical fibers in the vertical direction is also ensured.

In another embodiment of the method of manufacturing an optical fiber holding member of the invention, a deflection generating member for holding the optical fibers in a state in which the axial direction of the optical fibers are shifted with respect to the axial direction of the optical fibers in the grooves is provided in the molding die. Therefore, in this embodiment, by disposing the optical fibers between the grooves and the deflection generating member, deflection of the optical fibers can be generated in a simpler structure.

In still another embodiment of the method of manufacturing an optical fiber holding member of the invention, the holder is formed with an opening by the deflection generating member in the previous embodiment. In this embodiment since the holder is formed with the opening, which is formed by the deflection generating member, the deflection generating member is not inserted into the holder. Therefore, the deflection generating member can be used repeatedly, and hence the cost of the optical fiber holding member can be reduced.

In another embodiment of the method of manufacturing an optical fiber holding member of the present invention, in the second step, the position of the gate is set in the vicinity of the grooves so that resin flows in the direction substantially parallel with the direction of deflection of the optical fibers in the grooves. Therefore, in this embodiment, there is no risk of separation of the optical fibers, which is pressed against the grooves, from the grooves due to resin flow.

According to still another embodiment of the method of manufacturing an optical fiber holding member of the invention, members for alleviating impact exerted by resin flow at the time of molding the holder are disposed on both sides of the optical fibers. Therefore, the optical fibers can be prevented from dispersing in position due to the impact of flowing resin exerted at the time of molding.

According to still another embodiment of the method of manufacturing an optical fiber holding member of the invention, the positioning member can be slid in the direction parallel with the direction of arrangement of the grooves. According to this embodiment, the optical fibers can be deflected by sliding the positioning member after having placed the optical fibers in the grooves in a straight posture, whereby the optical fibers can be set in the grooves easily.

According to further embodiment of the method of manufacturing an optical fiber holding member of the invention, in the first step, a tension is provided to the optical fibers. In this embodiment, since the tension is provided to the optical fibers, the optical fibers are prevented from slanting, and hence the optical fibers can be brought into abutment reliably with the reference surface for positioning.

The optical fiber holding member according to the invention is an optical fiber holding member including a plurality of parallel optical fibers inserted into a resin holder, wherein the respective optical fibers are inserted into the holder in a state of being deflected in the direction orthogonal to the axial direction thereof.

An embodiment of an optical fiber holding member of the invention is characterized in that the end surfaces of the optical fibers are exposed at the end surface of the holder, and the axial direction of the optical fibers is obliquely inclined with respect to the normal line extending from the end surface of the optical fiber at least in part of the holder.

The optical fiber holding member of the present invention can be manufactured by the method of manufacturing an optical fiber holding member of the invention, and the optical fibers can be arranged at regular pitches with high degree of accuracy.

The components of the invention described above can be combined arbitrarily as much as possible.

According to the present invention, manufacture of the optical fiber holding member can be simplified, and the optical fibers can be arranged in the holder at regular pitches with high degree of accuracy.

### BRIEF DESCRIPTION OF THE DRAWINGS

FIG. 1 is a perspective view showing a method of manufacturing an optical fiber holding member in the related art;

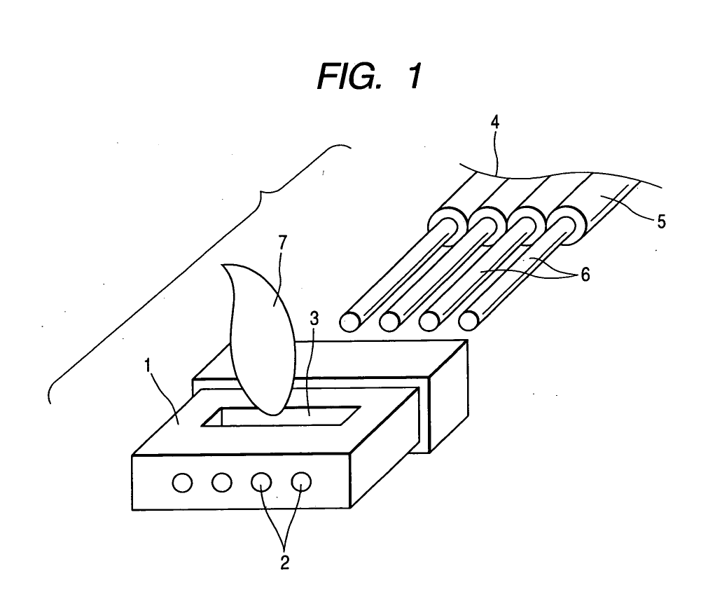

FIG. 2 is a perspective view showing another method of manufacturing an optical fiber holding member in the related art;

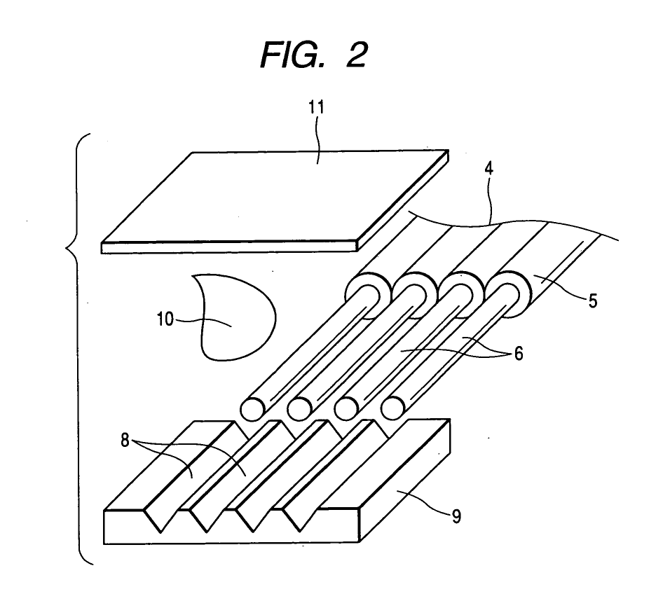

FIG. 3A is a drawing explaining the reason why the optical fibers are arranged at regular pitches by the optical fiber holding member shown in FIG. 2, and FIG. 3B is a drawing explaining the reason why the array pitch of the optical fibers is not constant;

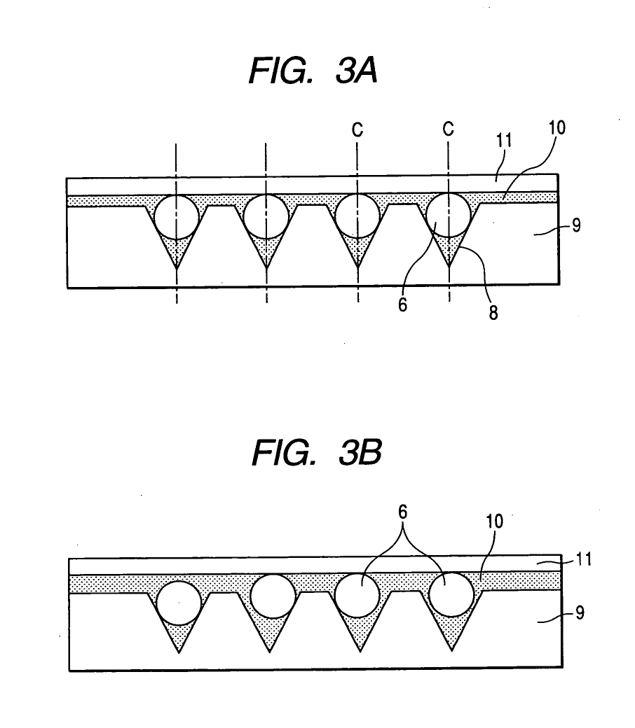

FIG. 4 is a perspective view showing a structure of an optical fiber holding member according to a first embodiment of the invention;

FIGS. 5A and 5B are a front view and a plan view thereof, respectively;

FIG. 6 is a perspective view showing a molding die for manufacturing the optical fiber holding member according to the first embodiment;

FIG. 7 is a perspective view of the upper die of the molding die shown in FIG. 6 in a state of being turned over;

FIG. 8 is a schematic drawing showing the upper die and the portion around the cavity of the lower die of the molding die in FIG. 6;

FIG. 9A is an enlarged perspective view showing the holding grooves of the deflection generating block which constitutes part of the lower die, and FIG. 9B is an enlarged perspective view showing the groove of the positioning block which constitutes part of the lower die;

FIG. 10 is a plan view showing a positional relation between the deflection generating block and the positioning block;

FIG. 11 is a side view partly broken, showing a tension device for gripping the optical fiber conductor wire clamped between the upper die and the lower die and providing a tension to the optical fiber;

FIG. 12 is a schematic side view showing another embodiment of the tension device;

FIG. 13 is a process flowchart showing a step of manufacturing the optical fiber holding member using the molding die as shown in FIG. 6;

FIG. 14 is a perspective view for explaining a process of setting the optical fibers on the lower die;

FIG. 15 is a perspective view explaining the process of molding the holder with the upper die and the lower die closed;

FIG. 16 is a plan view showing the optical fiber set on the deflection generating block and the positioning block;

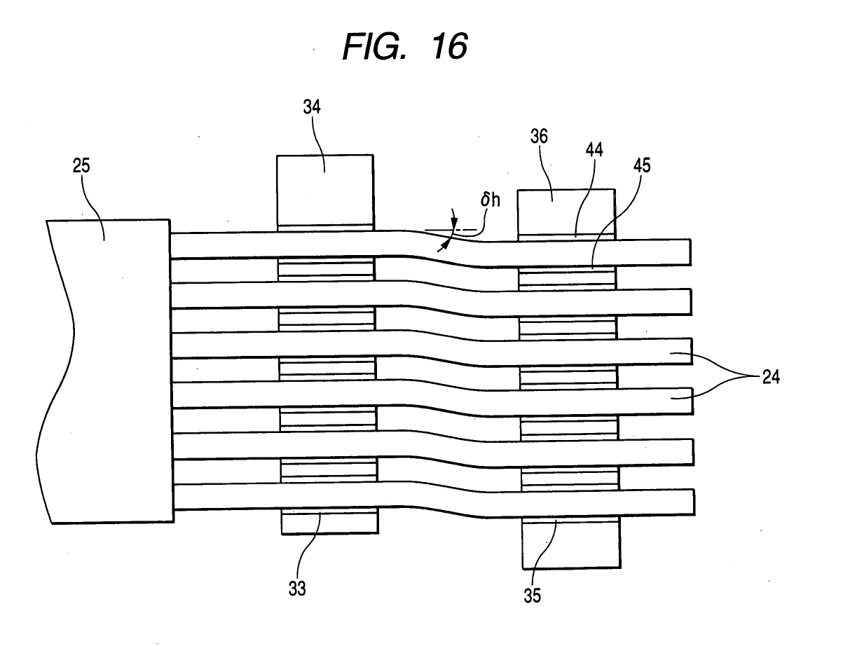

FIG. 17 is a vertical cross-sectional View showing the optical fiber set on the deflection generating block and the positioning block;

FIG. 18 is an explanatory drawing showing the position of the optical fibers in the holding grooves of the deflection generating block and the position of the optical fiber in the grooves of the positioning block;

FIG. 19 is an explanatory drawing showing the respective optical fibers positioned between the positioning block and the fiber holder;

FIG. 20 is a drawing showing the direction of resin flow at the time of molding the holder;

FIG. 21 is a drawing showing another example of the shape of the holding grooves of the deflection generating block and the shape of the grooves of the positioning block;

FIG. 22 is a an explanatory drawing showing the deflection generating block and the positioning block of a second embodiment of the invention;

FIG. 23 is a schematic drawing showing how the holder is molded according to a third embodiment of the invention;

FIG. 24 is a schematic drawing showing a structure of the upper die and the lower die according to a fourth embodiment of the invention;

FIG. 25 is a drawing showing part of upper die, the deflection generating block and the positioning block in an enlarged manner according to the fourth embodiment;

FIG. 26 is a drawing showing a process of setting the optical fibers in the fourth embodiment; and

FIG. 27 is an explanatory drawing explaining a fifth embodiment of the present invention.

### DESCRIPTION OF THE PREFERRED EMBODIMENTS

Referring now to the drawings, embodiments of the invention will be described in detail.

### First Embodiment

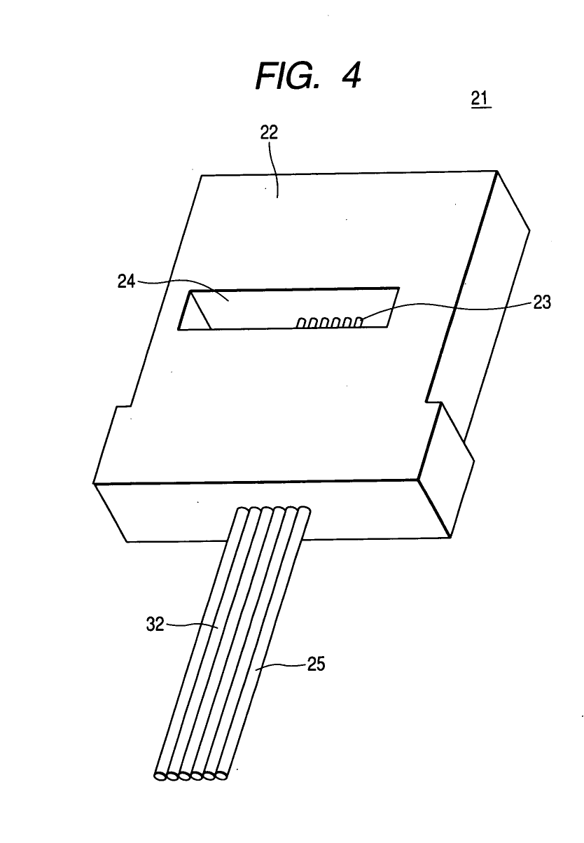

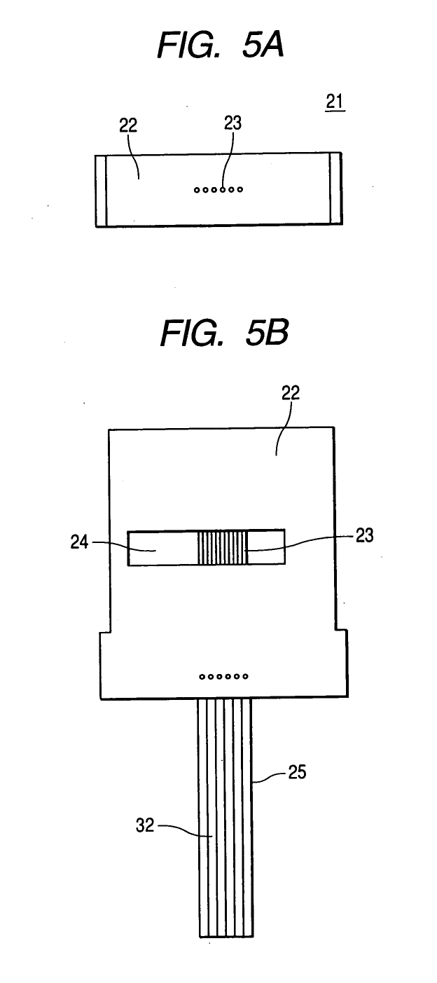

FIG. 4 is a perspective view showing a structure of an optical fiber holding member 21 according to a first embodiment of the invention, and FIG. 5A and FIG. 5B are a front view and a plan view thereof. The optical fiber holding member 21 is formed by insert molding with a plurality of optical fibers 23 (element wires), from which coatings 32 are removed, being arranged in a holder 22, which is a resin mold, at regular pitches. The holder 22 is formed with an opening 24 penetrated in the vertical direction, and optical fibers 23 are exposed through the opening 24. The end surfaces of the optical fibers 23 are exposed in line at regular pitches at the front end surface of the holder 22, and an optical fiber conductor wire 25 (tape conductor wire) extends rearwardly of the holder 22.

In the following description, the structure of the optical fiber holding member 21 is also clarified through the description of the method of manufacturing an optical fiber holding member 21.

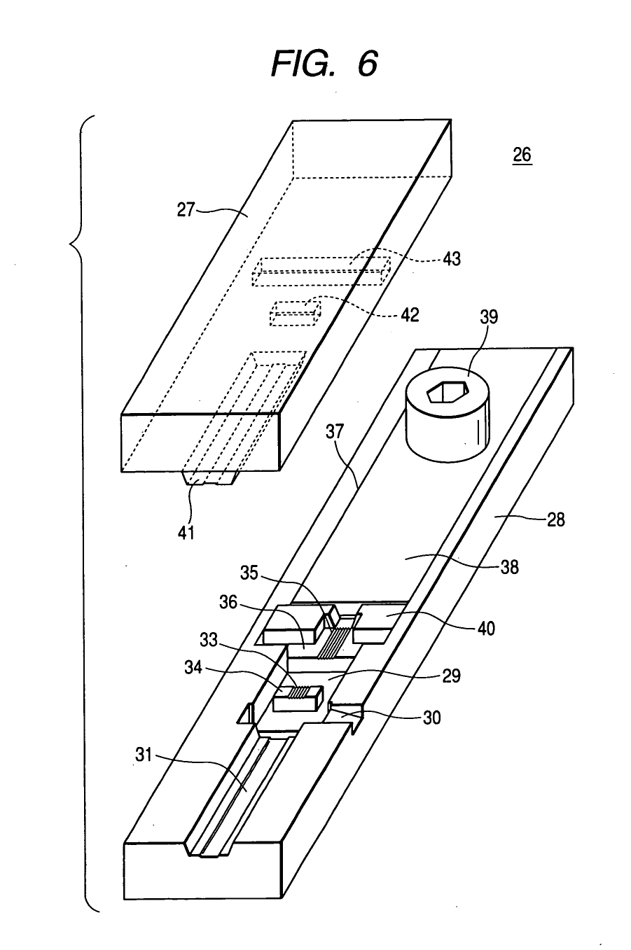

FIG. 6 shows a molding die 26 for manufacturing the optical fiber holding member 21. The molding die 26 includes an upper mold 27 and a lower mold 28 formed of steel, and the lower die 28 is fixed to the molding device, not shown, and the upper die 27 is adapted to move upward and downward along a guide pin.

The lower die 28 is formed with a cavity 29 for forming the holder 22, and a gate 30 for injecting resin is formed on one of the sides of the cavity 29. A cable holding groove 31 for placing the optical fiber conductor wire 25 is formed behind the cavity 29. A deflection generating block 34 formed with a plurality of holding grooves 33 for positioning a plurality of optical fibers 23 exposed from the coating 32 of the optical fiber conductor wire 25 at regular pitches is fixed to the center in the cavity 29. The lower half of the opening 24 of the holder 22 is formed by the deflection generating block 34. A positioning block (positioning member) 36 formed with a plurality of grooves 35 for positioning the plurality of optical fibers 23 at regular pitches is disposed in front of, and in contact with, the cavity 29. The lower half of the front surface of the holder 22 is formed by the rear surface of the positioning block 36.

On the opposite side of the positioning block 36 from the cavity 29, a recess 37 is formed on the upper surface of the lower die 28, and a clamper 38 is placed in the recess 37. The distal ends of the optical fibers 23 are inserted between the upper surface of the recess 37 of the lower die 28 and the clamper 38, and a clamper screw 39 is tightened, so that the distal ends of the optical fibers 23 can be gripped. Reference numeral 40 designates a pair of left and right restraining blocks, which restrains the optical fibers 23 from spreading out from each other between the grooves 35 and the clamper 38 when the optical fibers 23 are fitted in the grooves 35 of the positioning block 36 and the distal ends of the optical fibers 23 passed through the groove 35 are inserted below the clamper 38.

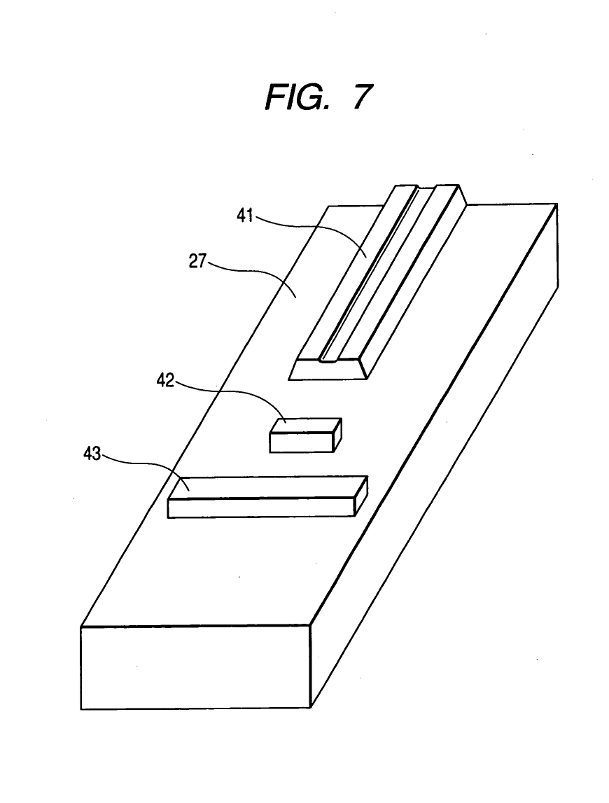

FIG. 7 is a perspective view of the upper die 27 showing the back side by being turned over. On the lower surface of the upper die 27 is provided with a cable holder 41 for holding the optical fiber conductor wire 25 and fiber holders 42, 43 for holding the optical fibers 23. The cable holder 41 is for holding the optical fiber conductor wire 25 placed within the cable holding groove 31 of the lower die 28. The fiber holder 42 is for holding the optical fibers 23 placed within the holding grooves 33 of the deflection generating block 34, and the upper half of the opening 24 of the holder 22 is formed by the fiber holder 42. The deflection generating block 34 and the fiber holder 42 constitutes a deflection generating member. The fiber holder 43 is for holding the optical fibers 23 placed within the grooves 35 of the positioning block 36, and the upper half of the front end surface of the holder 22 is formed by the back surface of the fiber holder 43.

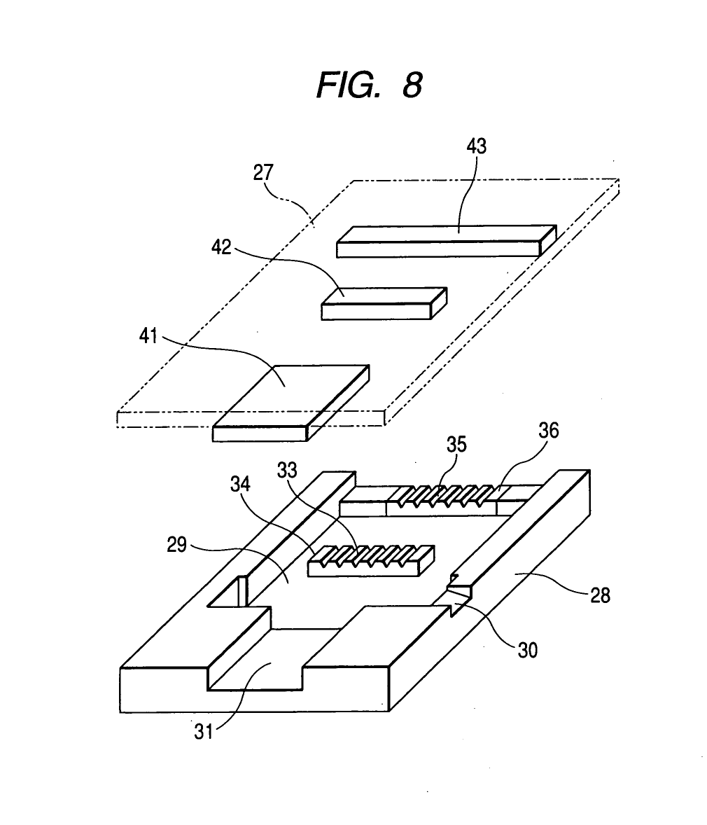

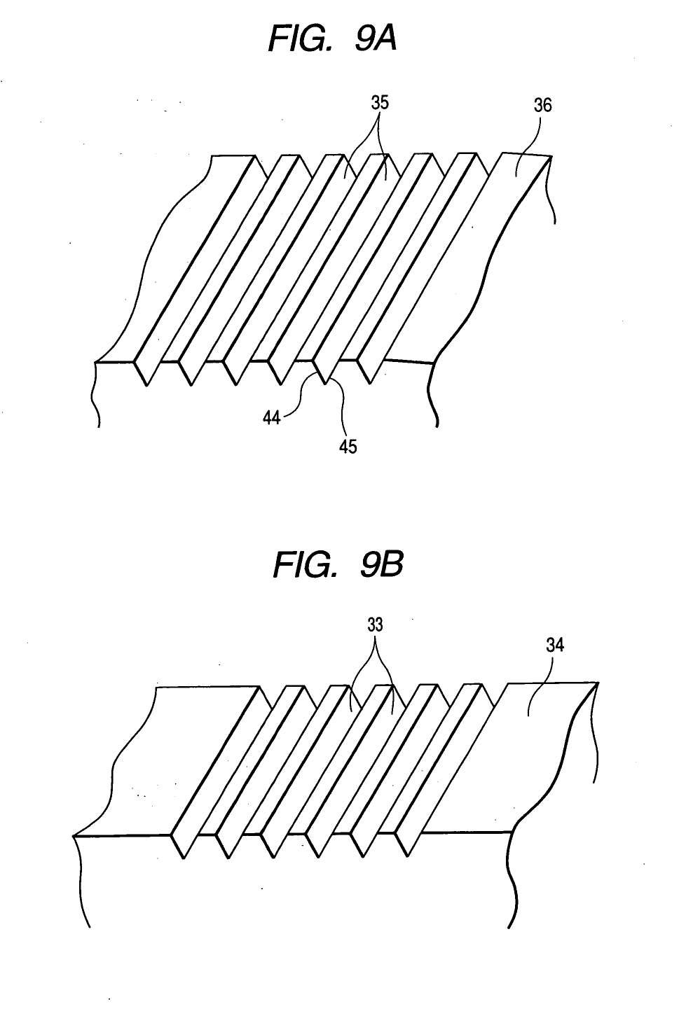

FIG. 8 is a schematic drawing showing the upper die 27 and the portion around the cavity of the lower die 28. FIG. 9A is an enlarged perspective view showing the holding grooves 33 of the deflection generating block 34, and FIG. 9B is an enlarged perspective view showing the groove 35 of the positioning block 36. The holding grooves 33 are V-shaped grooves, and are formed at regular pitches. The grooves 35 are formed at the same pitch as the holding grooves 33, and one side of each serves as an inclined positioning surface (reference surface for positioning) 44, and the other side is as inclined surface 45.

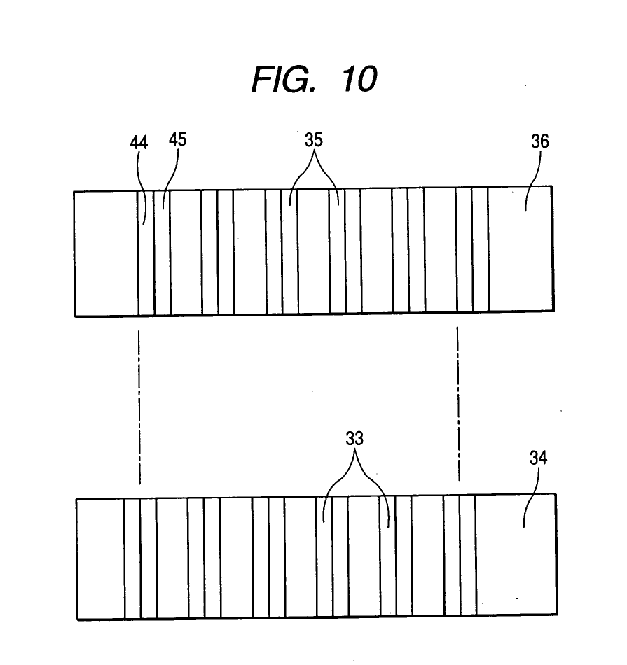

FIG. 10 is a plan view showing a positional relation between the deflection generating block 34 and the positioning block 36. As shown here, the holding grooves 33 of the deflection generating block 34 and the grooves 35 of the positioning block 36 extend in parallel with each other (fore-and-aft direction), but widthwise positions are shifted from each other, so that the holding grooves 33 of the deflection generating block 34 are slightly shifted toward the positioning surfaces 44 of the grooves 35 of the positioning block 36. The height of the optical fiber 23 held by the holding groove 33 of the deflection generating block 34 is slightly higher than the height of the optical fiber 23 held by the groove 35 of the positioning block 36.

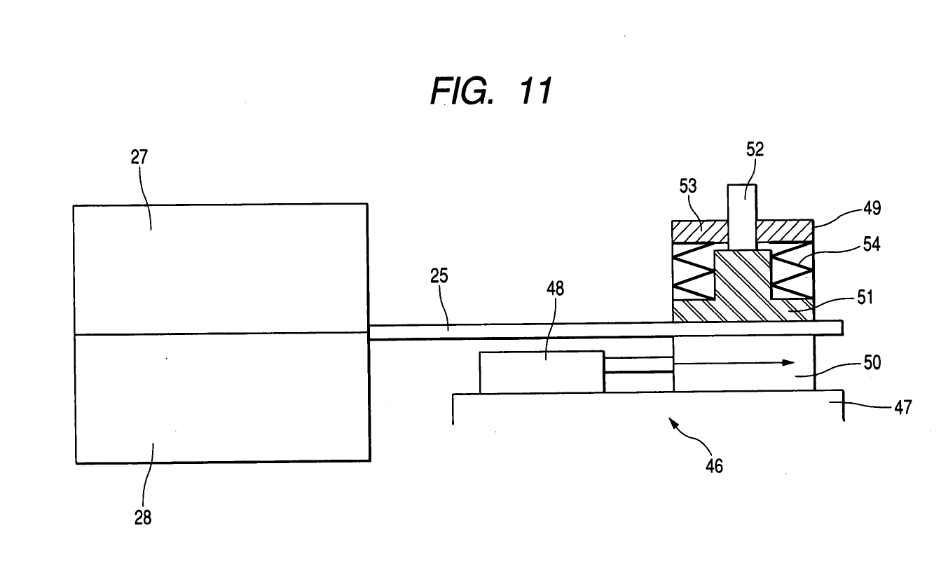

FIG. 11 shows a tension device 46 for gripping the optical fiber conductor wire 25 clamped between the upper die 27 and the lower die 28 and providing a tension to the optical fiber 23. The tension device 46 is constituted from an actuator 48 such as the air cylinder fixed on a table 47 of the molding device and the clamping device 49 slidably mounted on the table 47. The tension device 46 drives the actuator 48 in a state in which the optical fiber conductor wire 25 is clamped by the clamping device 49 and moves the clamping device 49 in the direction away from the upper and lower dies 27, 28, so that the optical fiber conductor wire 25 is pulled, and the tension is exerted to the optical fibers 23 clamped between the upper and lower dies 27, 28 with a relatively small force (for example, on the order of 800 g).

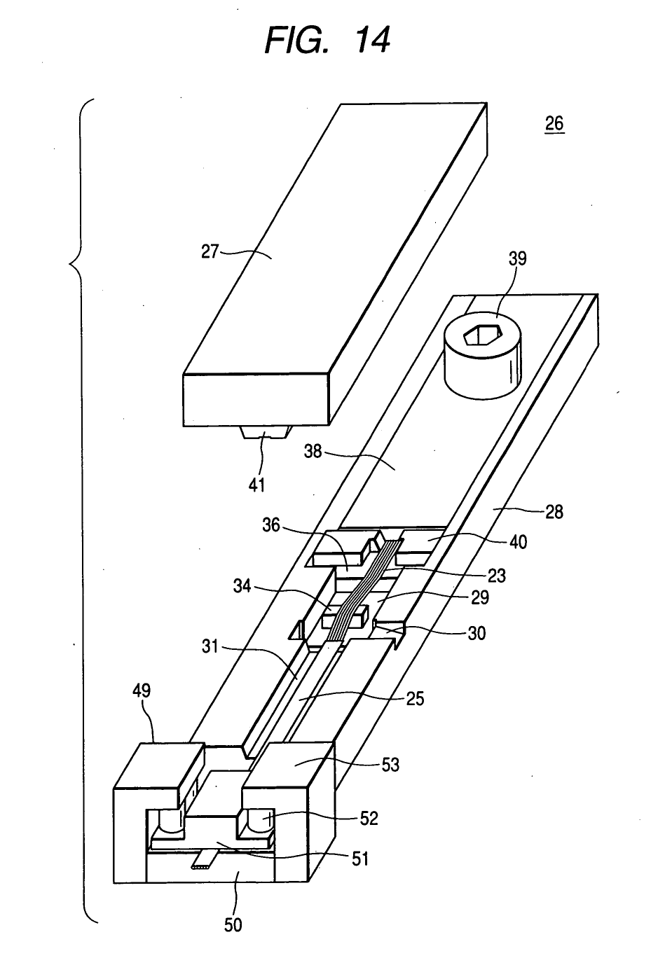

The clamping device 49 is adapted to clamp the optical fiber conductor wire 25 between a supporting base 50 and a holding plate 51. Guide pins 52 are provided on the upper surface of the holding plate 51 on both sides thereof, and the guide pins 52 are slidably held by a pin supporting portion 53 formed integrally with the supporting base 50, so that the holding plate 51 is slidable in the vertical direction with respect to the supporting base 50. The holding plate 51 is pushed down by a compression spring 54 inserted between the pin supporting portion 53 and the holding plate 51 (see FIG. 14). Therefore, by inserting the optical fiber conductor wire 25 into a gap between the supporting base 50 and the holding plate 51, the optical fiber conductor wire 25 can be gripped.

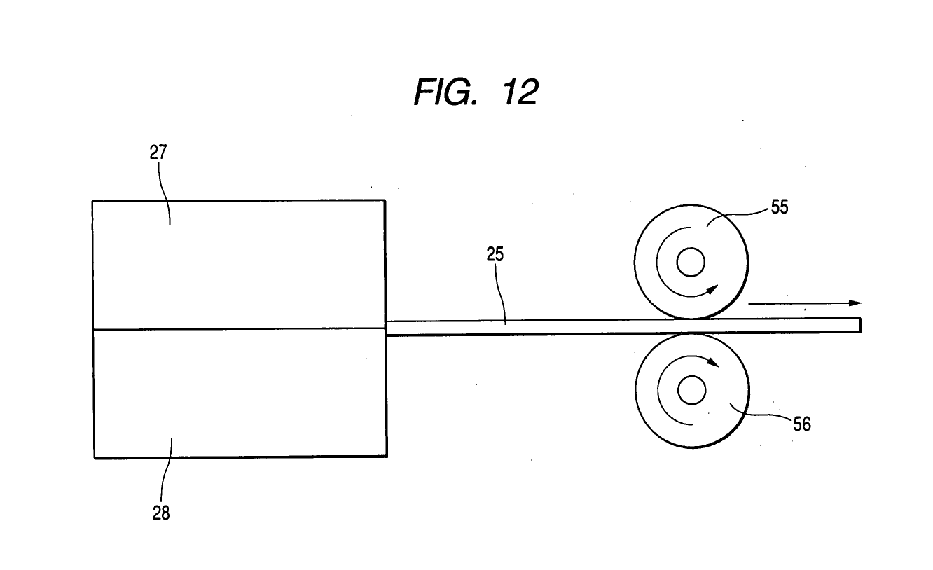

A structure shown in FIG. 12 is also applicable as the tension device 46. The tension device 46 shown in FIG. 12 includes a pair of upper and lower rolls 55, 56, and the optical fiber conductor wire 25 is clamped between the upper and lower rolls 55, 56. By rotating the rolls 55, 56 in the direction indicated by arrows in FIG. 12 and pulling the optical fiber conductor wire 25, a tension is provided to the optical fiber 23.

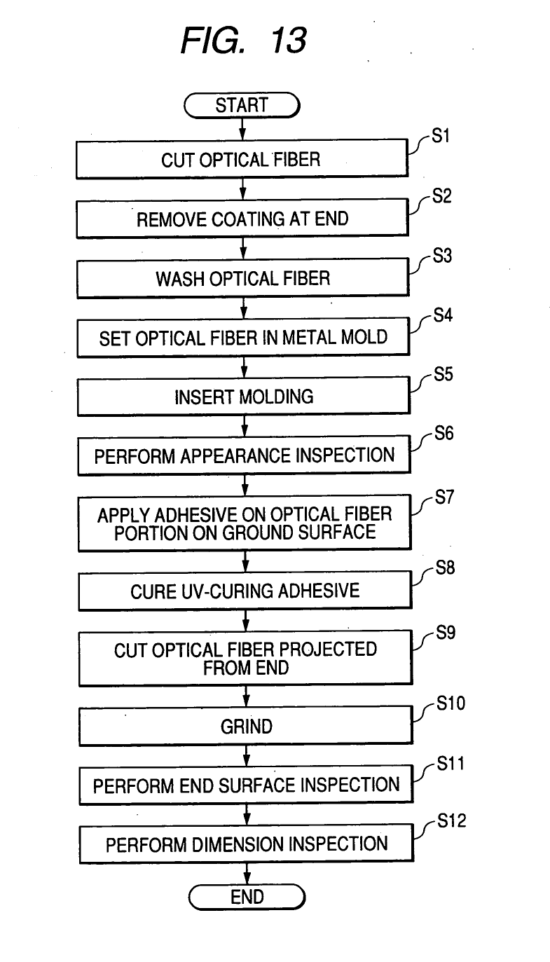

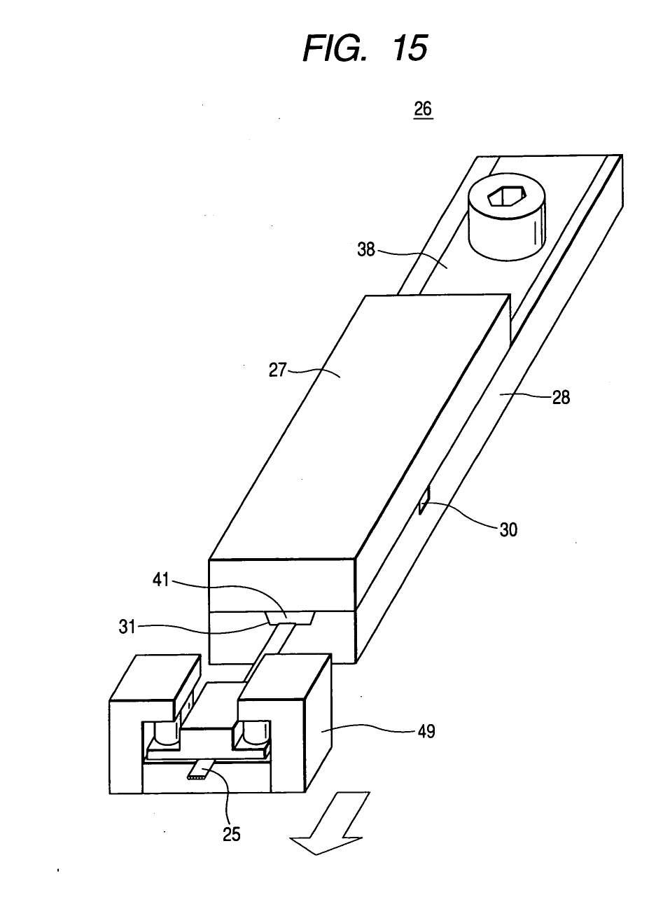

FIG. 13 is a process flowchart showing a step of manufacturing the optical fiber holding member 21 using the molding die 26 as described above. FIG. 14 and FIG. 15 show processes in Steps S4 and S5. Referring to FIG. 13, a process of manufacturing the optical fiber holding member 21 will be described below. For example, the optical fiber conductor wire 25 of 6-core, single mode, is cut by a cutting tool, such as a nipper, into an adequate length (Step S1), and the coating 32 at the end of the optical fiber conductor wire 25 is removed using a specific jig, such as a stripper, to expose the ends of the optical fibers 23 from the coating 32 (Step S2). Then, the optical fiber 23 is washed (Step S3).

Then, as shown in FIG. 14, the optical fibers 23 are set on the lower die 28 (Step S4). In other words, the optical fiber conductor wire 25 is placed in the cable holding grooves 31, then the respective optical fibers 23 exposed from the coating 32 are fitted into the individual holding grooves 33 of the deflection generating block 34, and then the distal ends of the respective optical fibers 23 are placed in the individual grooves 35 of the positioning block 36. Then, the clamper spring 39 are left loosened, the distal ends of the respective optical fibers 23 are inserted below the clamper 38, and the clamper screw 39 is tightened to fix the distal end of the optical fiber 23. Then, the coated portion of the optical fiber conductor wire 25 is passed between the holding plate 51 of the clamping device 49 and the supporting base 50 to be resiliently clamped.

Then, as shown in FIG. 15, the clamping device 49 is pushed and moved by the actuator 48 to pull the optical fiber conductor wire 25, and the upper die 27 is moved downward while applying a light tension to the optical fibers 23. When the upper die 27 is moved downward to close between the upper die 27 and the lower die 28, the molding cavity 29 is defined between the upper die 27 and the lower die 28, and the optical fiber conductor wire 25 in the cable holding groove 31 is pressed and held by the cable holder 41. The optical fiber 23 is clamped between the fiber holder 42 and the deflection generating block 34, and is clamped between the fiber holder 43 and the positioning block 36.

In this state, by injecting thermoplastic resin (for example, epoxy resin of low contraction percentage), which is low in viscosity and high in flowability, into the cavity 29 from the gate 30, and injection molding the holder 22, the optical fibers 23 is inserted into the molded holder 22 (Step S5). After having done the insertion molding as described above, the molding die 26 is opened, the clamper screw 39 is loosened to release the distal ends of the optical fibers 23 from the clamper 38, and the optical fiber holding member 21 is taken out from the lower die 28.

In the optical fiber holding member 21 molded as described above, the holder 22 is formed with an opening 24 by the fiber holder 42 and the deflection generating block 34, and the distal ends of the optical fibers 23 that passed through the opening 24 are projected from the front end surface of the holder 22.

After having conducted an appearance test of the half-completed optical fiber holding member 21 by a microscope (Step S6), UV-cured adhesive is applied to the portion of the optical fibers of the ground surface (the front end surface of the holder 22) (Step S7), and UV ray is irradiated to harden the optical fibers 23 projected from the front end surface of the holder by the UV cured adhesive (Step S8). Then, the ends of the optical fibers 23 projected from the front end surface of the holder 22 are cut by a nipper or the like (Step S9).

Subsequently, the optical fiber holding member 21 is set to the grinding device together with abrasives, and the front end surface of the optical fiber holding member 21, in particular, the end surface of the optical fiber 23 is ground precisely and finished into a smooth surface (Step S10). Then, an end surface inspection (Step S11) and a dimension inspection (Step S12) are conducted and when passed, it is delivered as a product.

According to the manufacturing method as described above, the optical fiber holding member 21 can be manufactured easily by inserting the optical fibers 23 arranged at regular pitches and conducting injection molding, and the productivity of the optical fiber holding member 21 can be improved while reducing the cost. By manufacturing the optical fiber holding member 21 in this manner, the optical fiber holding member 21 can be manufactured by using the precisely machined deflection generating block 34 or the positioning block 36, the accuracy of the array pitch of the optical fibers 23 can be improved, while the cost of the optical fiber holding member 21 can be reduced by using the costly deflection generating block 34 or the positioning block 36 repeatedly.

In the molding die 26 as described above, since the respective holding grooves 33 of the deflection generating block 34 are shifted toward the positioning surfaces 44 with respect to the respective grooves 35 of the positioning block 36 as described in conjunction with FIG. 10, when the optical fibers 23 are fitted to the respective holding grooves 33 of the deflection generating block 34 and the respective grooves 35 of the positioning block 36 respectively, the respective optical fibers 23 are bent in a horizontal plane between the deflection generating block 34 and the positioning block 36, and the positions of the optical fibers 23 in the holding grooves 33 and the positions of the optical fibers 23 in the grooves 35 are shifted in the horizontal direction. The angle of deflection between the position of the optical fibers 23 in the holding grooves 33 and the position thereof in the grooves 35 in a horizontal plane is on the order of δh=0.1°-1°.

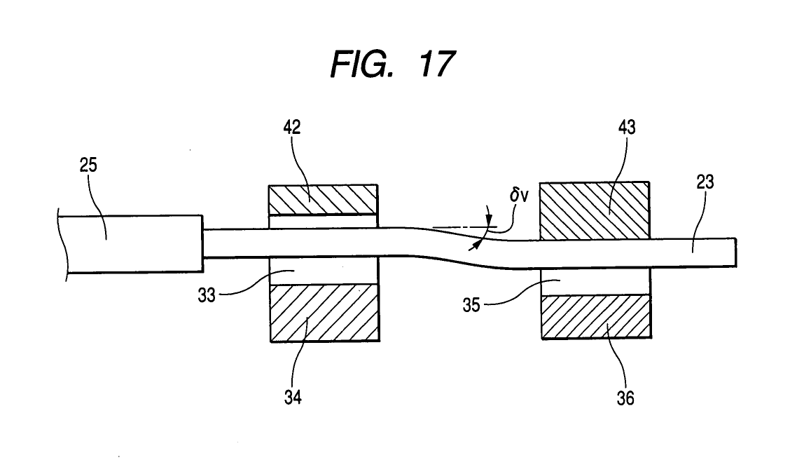

The height of the optical fibers 23 held in the holding grooves 33 of the deflection generating block 34 is slightly higher than the height of the optical fiber 23 held by the groove 35 of the positioning block 36. In other words, when viewed along the vertical cross-section, as shown in FIG. 17, the distal sides of the optical fibers 23 placed in the grooves 35 of the positioning block 36 and pressed by the fiber holder 43 are pressed downward with respect to the proximal sides of the optical fibers 23 placed in the holding grooves 33 of the deflection generating block 34 and pressed by the fiber holder 42, and hence the respective optical fibers 23 are bent in a vertical plane between the deflection generating block 34 and the positioning block 36. The angle of deflection of the optical fibers 23 in the vertical plane between the positions of the optical fibers 23 in the holding grooves 33 and the positions thereof in the grooves 35 is on the order of δv=0.1°-1°.

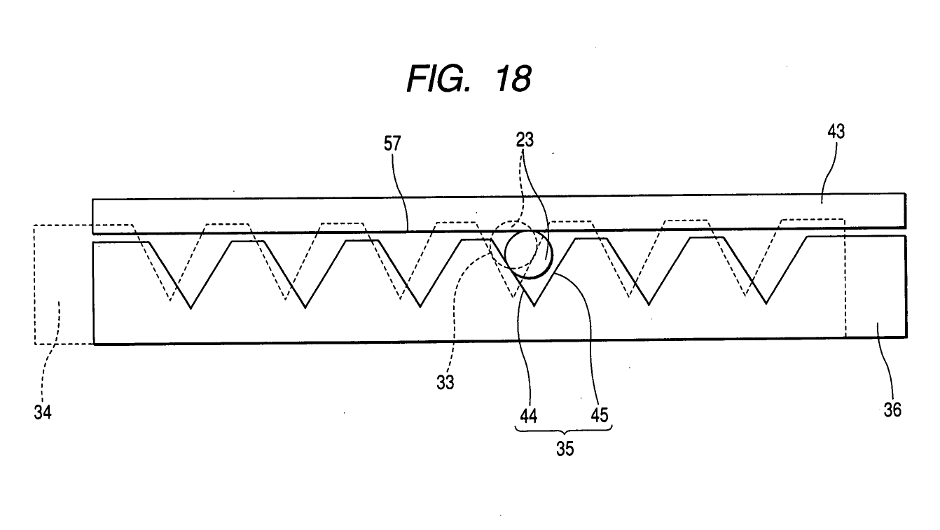

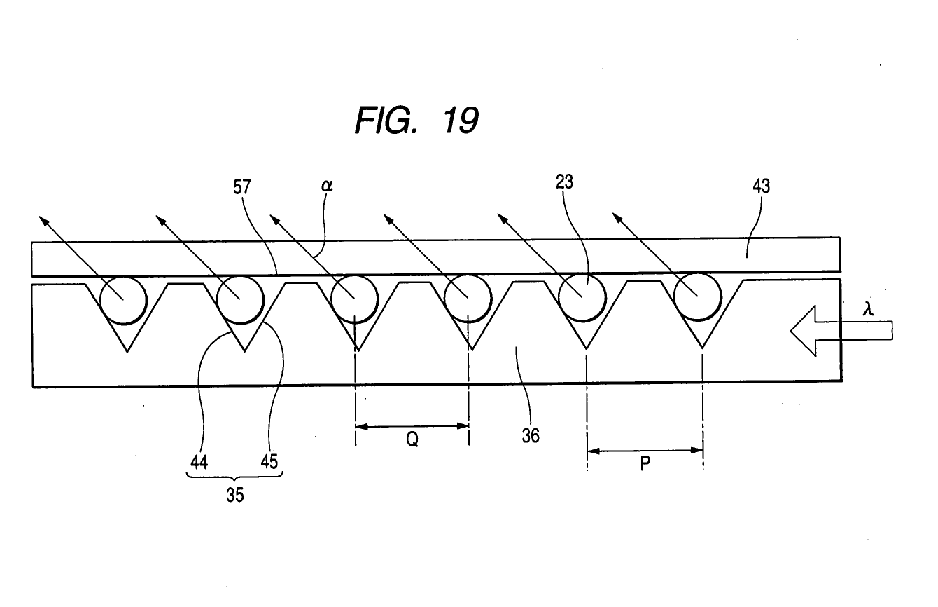

Consequently, when viewed from the direction of the cable holding groove 31, as shown in FIG. 18 and FIG. 19, the positions of the cross sections of the optical fibers 23 in the holding grooves 33 of the deflection generating block 34 are positioned on the upper left of the position of the cross sections of the optical fibers 23 in the grooves 35 of the positioning block 36, whereby the respective optical fibers 23 are urged in the upper left direction by a resilient force α in the groove 35, and are forcedly pressed against the positioning surface 44 of the grooves 35 and the lower surface (reference surface of positioning) 57 of the upper die 27. Therefore, as shown in FIG. 19, as long as the pitches of the grooves 35 on the positioning surface 44 is formed with high degree of accuracy, and the lower surface of the fiber holder 43 is formed into a flat surface, the respective optical fibers 23 are positioned by a corner formed by the positioning surface 44 and the lower surface 57 of the fiber holder 43 with a resilient force α, and are arranged at regular pitches Q with the same accuracy as the pitches P of the positioning surface 44. In other words, as in the related art, the optical fibers 23 can be prevented from lifting from the reference surface, that is, from the positioning surface 44 and the lower surface 57 of the fiber holder 43 and dispersing in array pitch.

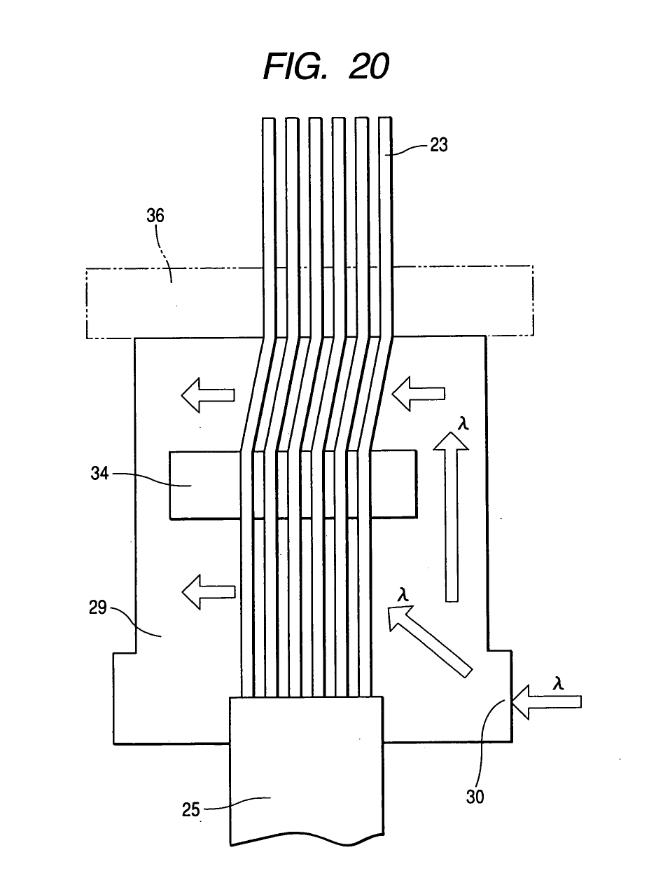

FIG. 20 shows a state in which resin is injected into the cavity 29 for forming the holder 22. The gate 30 is provided on one of the side surfaces of the cavity 29, and resin injected from the gate 30 into the cavity 29 flows as indicated by an arrow λ in FIG. 20. The gate 30 is provided on the side surface (right side surface) on the side of the inclined surface 45 of the grooves 35 having the positioning surfaces 44 and the inclined surfaces 45 respectively. The deflection generating block 34 and the fiber holder 42 are shifted toward the side opposite from the gate 30. Consequently, the passage of resin between the deflection generating block 34 and the fiber holder 42 and the right side surface of the cavity 29 is wide, while the passage of resin between the deflection generating block 34 and the fiber holder 42 and the left side surface of the cavity 29 is narrow. The width of the narrow resin passage on the left side of the deflection generating block 34 and the fiber holder 42 can be determined considering the strength of the corresponding portion of the holder 22 or the filling state of resin in the corresponding portion.

When resin is injected from the gate 30 into the cavity 29 in this manner, resin flows as shown by an arrow λ in FIG. 20, and in the vicinity of the positioning block 36, as shown in FIG. 19, resin flows from the side of the inclined surface 45 to the side of the positioning surface 44, and the optical fibers 23 are pressed against the positioning surface 44 by the flow of the resin. The resin passage on the left side of the deflection generating block 34 and the fiber holder 42 is narrow and hence resin hardly runs through, and thus resin hardly runs from the side of the positioning surface 44 to the side of the inclined surface 45 in the vicinity of the positioning block 36. Therefore, the optical fibers 23 are prevented from lifting from the positioning surface 44 or vibrating due to the flow of resin, and thus the accuracy of the array pitch of the optical fibers 23 can be improved. When the gates are provided on the left and right sides of the cavity, or when the deflection generating block and the fiber holder are disposed at the center of the cavity, the optical fibers 23 vibrate and are lifted from the positioning surface 44 or the like when resin flows, and hence an error of several μm may be generated. However, according to the first embodiment, such an error may be eliminated, and hence the accuracy of array pitch of the optical fibers 23 can be improved.

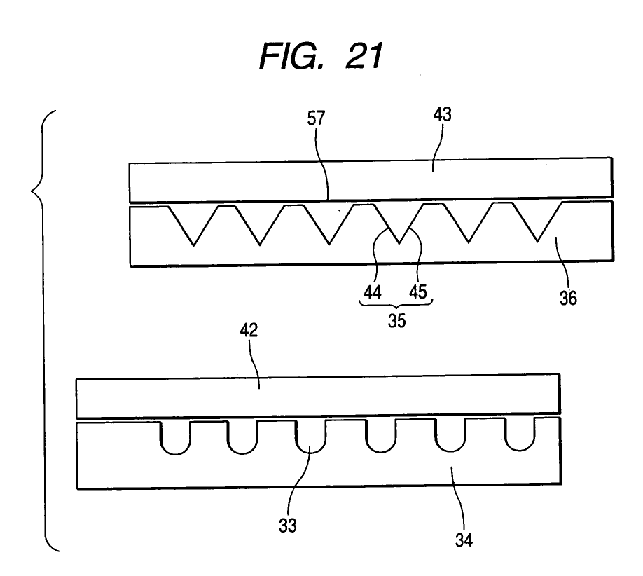

As is clear from the description of the first embodiment described above, the holding grooves 33 of the deflection generating block 34 are not limited to the V-groove. In particular, it may be the holding grooves 33 of U-shape as shown in FIG. 21. The shape of the groove 35 is not limited to the V-shape as well.

### Second Embodiment

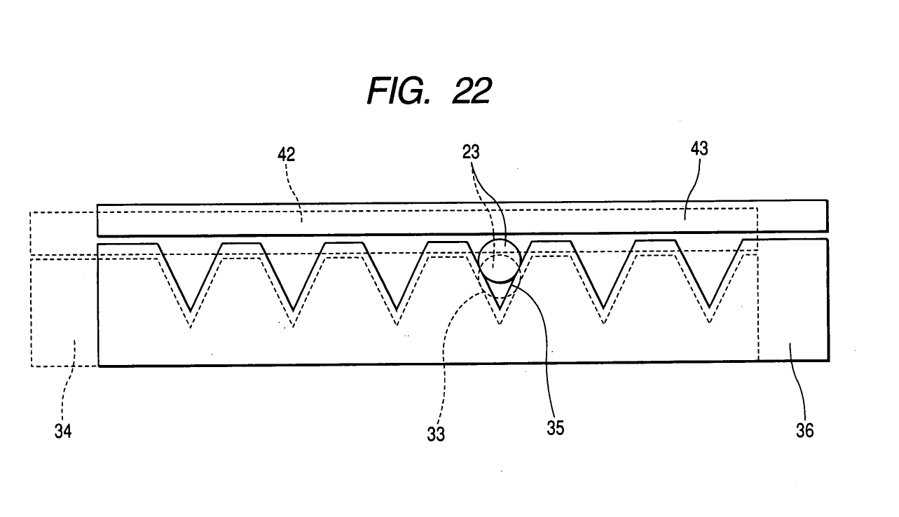

FIG. 22 is an explanatory drawing of a second embodiment of the invention. In the second embodiment, the holding grooves 33 of the deflection generating block 34 and the grooves 35 of the positioning block 36 are formed into V-shape. Then, by setting the height of the holding grooves 33 of the deflection generating block 34 to be lower than the height of the grooves 35 of the positioning block 36 and pressing the optical fibers 23 by the fiber holder 42, the optical fibers 23 is resiliently pressed into the grooves 35 in the positioning block 36.

In this embodiment as well, the optical fibers 23 can be arranged at regular pitches with high degree of accuracy by the grooves 35 of the positioning block 36.

### Third Embodiment

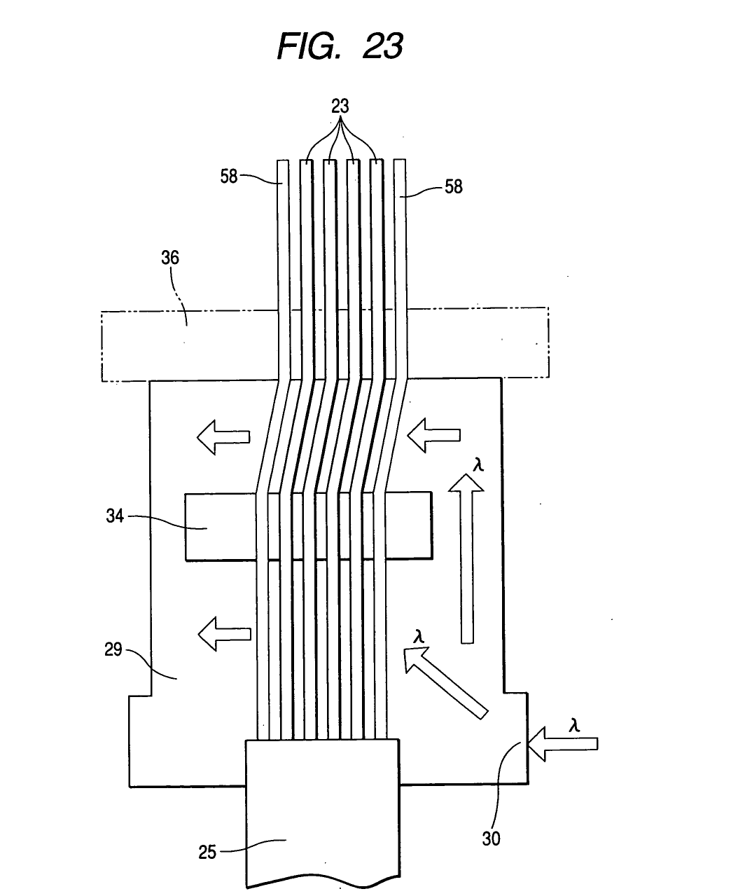

FIG. 23 is an explanatory drawing of a third embodiment of the invention. In the optical fiber conductor wire 25 used in the third embodiment, the optical fibers on left and right sides are dummy fibers 58. The dummy fibers 58 are not used for transmission of optical signals. For example, it may be the normal optical fibers which are not used for transmission of signals, or may be transparent or opaque fiber which simply has the same diameter as the optical fiber but cannot be used for light transmission. In this embodiment, since the dummy fibers 58 are provided on both sides of the optical fibers 23 for transmitting optical signals, when resin is injected into the cavity 29 as shown in FIG. 23, the resin does not come into direct contact with the optical fibers 23, and hence the flow of resin is alleviated by the dummy fiber 58. Therefore, according to this embodiment, displacement or vibration of the optical fibers 23 due to first impact of flowing resin flowing may be alleviated, and hence the accuracy of the array pitch of the optical fibers 23 can be improved.

It is also possible to dispose pins of small diameter in the die on both sides of the optical fibers 23 without using the dummy fibers 58. In this case, the pins of small diameter are disposed apart from the optical fibers 23 to a small distance, such as approximately 0.25 mm.

### Fourth Embodiment

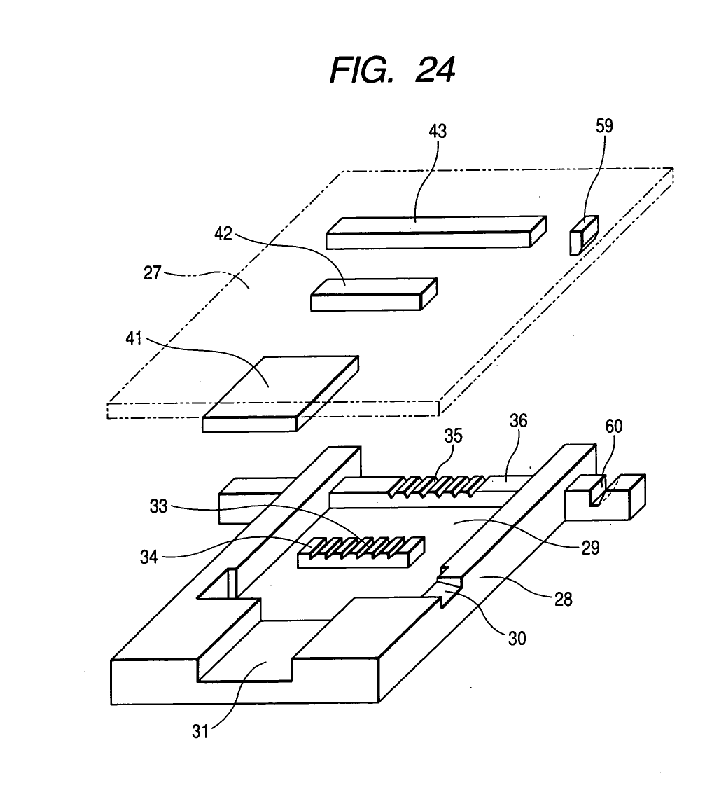

FIG. 24 is a schematic drawing showing a structure of the upper die 27 and the lower die 28 according to a fourth embodiment of the invention. In this embodiment, the positioning block 36 is slidable in the lateral direction with respect to the lower die 28. The upper surface of the end of the positioning block 36 is provided with a driven portion 60, and the position on the lower surface of the upper die 27 opposing to the driven portion 60 is provided with a drive portion 59 hung therefrom.

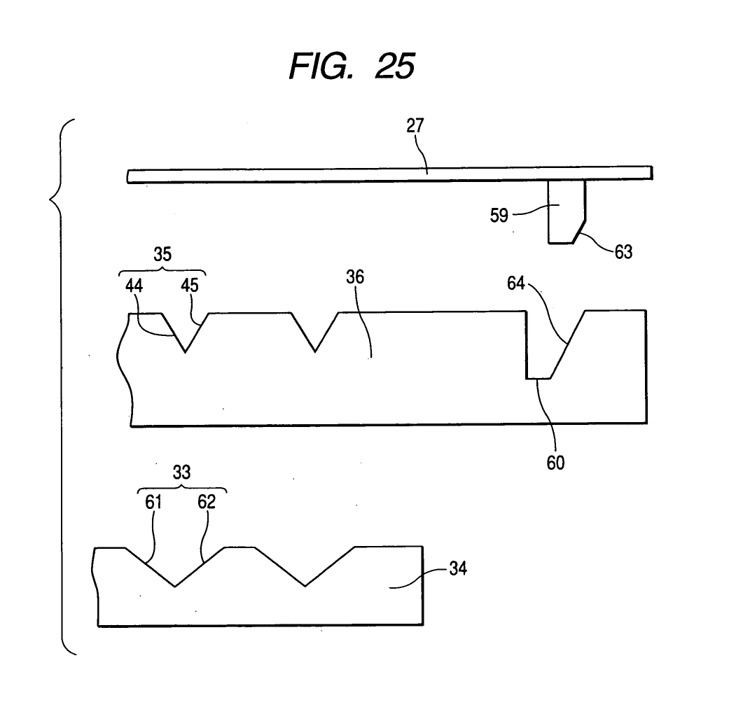

FIG. 25 is a drawing showing part of the upper die 27, deflection generating block 34 and the positioning block 36 in an enlarged manner. The upper surface of the end of the positioning block 36 is provided with a groove-shaped or a hole-shaped driven portion 60, and the side surface of the driven portion 60 is formed with an inclined surface 64. The side surface of the drive portion 59 hung from the lower surface of the upper die 27 is formed with an inclined surface 63 inclined at the same angle with the inclined surface 64 and coming into contact with the inclined surface 64. The positioning block 36 is formed with the grooves 35 including the inclined positioning surfaces 44 and the inclined surfaces 45 at regular pitches. The deflection generating block 34 is formed with the holding grooves 33 including the inclined surfaces 61 and the inclined surfaces 62 at regular pitches. The holding grooves 33 have the same shape as the grooves 35, and are formed at the same pitches.

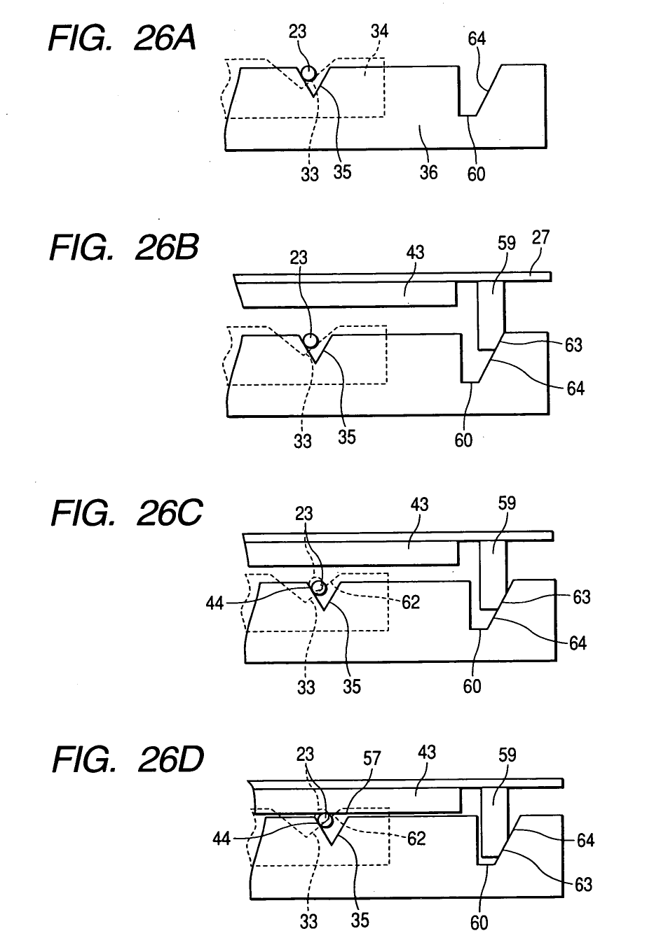

FIG. 26 is a drawing showing a process of setting the optical fibers 23 in the fourth embodiment. Since the holding grooves 33 of the deflection generating block 34 and the grooves 35 of the positioning block 36 are aligned in the same straight line as shown in FIG. 26A in the initial state, the optical fibers 23 can be set into the holding grooves 33 and the grooves 35. When the holding grooves 33 and the grooves 35 are aligned in the same straight line, the optical fibers 23 can be placed in a straight posture between the holding grooves 33 and the grooves 35, it is particularly convenient when the optical fibers 23 are set by a machine.

When the optical fibers 23 are set in the holding grooves 33 and the grooves 35, the upper die 27 is moved downward onto the lower die 28. When the upper die 27 is moved downward, as shown in FIG. 26B, the drive portion 59 is inserted into the driven portion 60, and the inclined surface 63 of the drive portion 59 comes into contact with the inclined surface 64 of the driven portion 60.

Then, when the upper die 27 is further moved downward, as shown in FIG. 26C, the inclined surface 64 is pressed by the inclined surface 63 and the positioning block 36 is moved in the horizontal direction. When the positioning block 36 is moved in the horizontal direction (rightward of FIG. 26), the optical fibers 23 climb up the inclined surface 62 in the holding grooves 33, move toward the upper left direction, and are pressed against the positioning surfaces 44 in the grooves 35.

When the upper die 27 is moved further downward, the optical fibers 23 in the holding grooves 33 climb further up the inclined surface 62, move toward the upper left, and then the optical fibers 23 in the grooves 35 are pressed by the positioning surface 44, and also by the lower surface 57 of the fiber holder 43. This is the same state as the first embodiment. Therefore, according to the fourth embodiment as well, the optical fibers 23 are arranged at regular pitches with high degree of accuracy to be molded in the holder 22 by insert molding.

### Fifth Embodiment

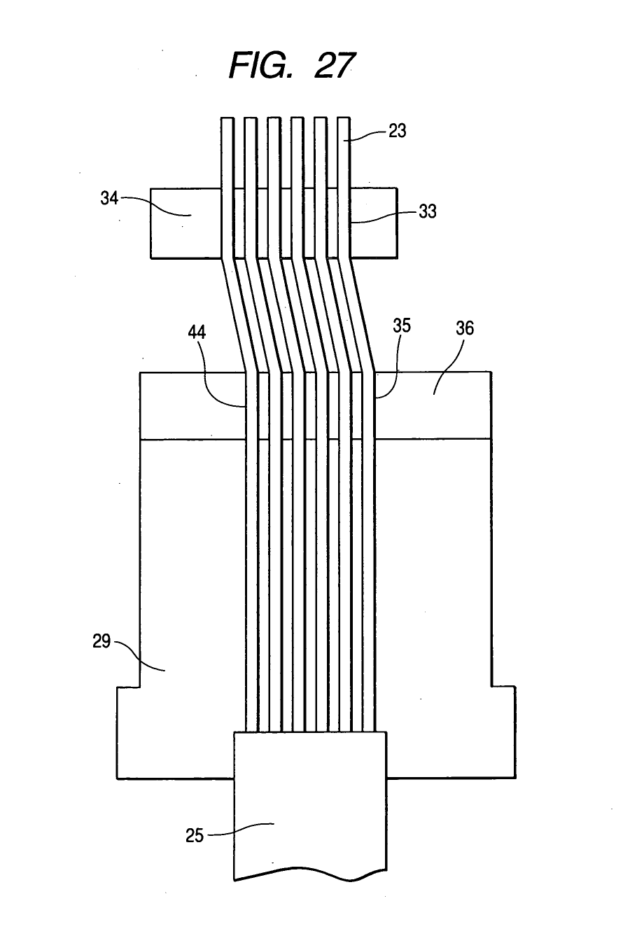

FIG. 27 is an explanatory drawing of a fifth embodiment according to the invention. In this embodiment, the positioning block 36 and the fiber holder 43 are formed of metal or ceramic material or the like, and are adapted to be inserted into the holder 22 with the optical fiber 23. On the other hand, the deflection generating bock 34 and the fiber holder 42 are disposed outside the cavity 29, and the axial directions of the optical fibers 23 are shifted on the distal sides of the optical fibers 23 so that a tension is generated on the optical fibers in the grooves 35.

The invention relates to the optical fiber holding member in which the end surfaces of the optical fibers for transmitting light signals are held at regular pitches, and for example, can be used for a connector or the like of the optical fiber conductor wire.

1. A method of manufacturing an optical fiber holding member by inserting a plurality of optical fibers arranged in parallel into a resin holder, comprising:
a first step of arranging the respective optical fibers in parallel to each other in a plurality of positioning grooves in a cavity of a molding die and pressing the respective optical fibers against the grooves while causing the respective optical fibers to deflect in the direction substantially orthogonal to the axial direction thereof, and
a second step of filling resin in the cavity of the molding die for forming the holder.

2. A method of manufacturing an optical fiber holding member according to claim 1, wherein the positioning member formed with the grooves is disposed at the position adjacent to the cavity of the molding die.

3. A method of manufacturing an optical fiber holding member according to claim 1, wherein, in the first step, the reference surface for pressing and positioning is placed on the positioning member formed with the grooves, and the optical fibers are deflected in the direction substantially orthogonal to the axial direction thereof and the respective optical fibers are pressed against the reference surface for pressing and positioning.

4. A method of manufacturing an optical fiber holding member according to claim 1, wherein a deflection generating member for holding the optical fibers in a state in which the axial direction of the optical fibers are shifted with respect to the axial direction of the optical fibers in the grooves is provided in the molding die.

5. A method of manufacturing an optical fiber holding member according to claim 4, wherein the holder is formed with an opening by the deflection generating member.

6. A method of manufacturing an optical fiber holding member according to claim 1, wherein, in the second step, the position of the gate is set so that resin flows in the direction substantially parallel with the direction of deflection of the optical fibers in the grooves in the vicinity of the grooves.

7. A method of manufacturing an optical fiber holding member according to claim 1, wherein members for alleviating impact exerted by resin flow at the time of molding the holder are disposed on both sides of the optical fibers.

8. A method of manufacturing an optical fiber holding member according to claim 1, wherein the positioning member can be slid in the direction parallel with the direction of arrangement of the grooves.

9. A method of manufacturing an optical fiber holding member according to claim 1, wherein, in the first step, a tension is provided to the optical fibers.

10. An optical fiber holding member comprising a plurality of parallel optical fibers inserted into a resin holder, wherein the respective fibers are inserted into the holder in a state of being deflected in the direction orthogonal to the axial direction thereof.

11. An optical fiber holding member according to claim 10, wherein the end surfaces of the optical fibers are exposed at the end surface of the holder, and the axial direction of the optical fibers is obliquely inclined with respect to the normal line extending from the end surface of the optical fiber at least in part of the holder.
